(19) United States
(12) Patent Application Publication
(10) Pub. No.: US 2014/0156874 A1
(43) Pub. Date: Jun. 5, 2014

(54) METHOD AND SYSTEM FOR A MULTIMEDIA DEVICE OPERABLE BY A CONTROL DEVICE

(71) Applicant: THOMSON LICENSING, Issy de Moulineaux (FR)

(72) Inventor: Stephane Haziza, Woodland Hills, CA (US)

(73) Assignee: THOMSON LICENSING, Issy de Moulineaux (FR)

(21) Appl. No.: 13/691,059

(22) Filed: Nov. 30, 2012

(51) Int. Cl. G06F 3/00

(52) U.S. Cl. CPC G06F 3/00
USPC 710/14

(57) ABSTRACT

The disclosed embodiments relate to a system and method for disabling control inputs to a multimedia device. More specifically, there is provided a method including determining, in response to receiving a do not interfere (DNI) control input from a control device for the multimedia device, that the multimedia device is operating in a DNI mode. In the DNI mode, the multimedia device persistently maintains a state of the multimedia device. The method also includes operating the multimedia device according to the DNI mode, in response to receiving an operation control input. The operation control input represents a request to change the state.

### FIELD OF THE INVENTION

The present invention involves operating a multimedia device. More specifically, the present invention relates to a system for a multimedia device operable by a control device.

### BACKGROUND OF THE INVENTION

This section is intended to introduce the reader to various aspects of art, which may be related to various aspects of the present invention that are described or claimed below. This discussion is believed to be helpful in providing the reader with background information to facilitate a better understanding of the various aspects of the present invention. Accordingly, it should be understood that these statements are to be read in this light, and not as admissions of prior art.

Home theater and entertainment systems include any number of multimedia devices, which operate based on inputs received from a remote control or other control device. For example, it is possible to play a movie, video game, or other multimedia experience, using a remote control to operate a set top box or television. In many systems, control devices include numerous keys to support various functionalities. As such, an inadvertent press of one or more keys while enjoying a movie, or other entertainment, may disrupt the experience.

An improved system or method for a multimedia device operable by a control device is desirable.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to a system and method for a multimedia device operable by a control device. More specifically, there is provided a method that includes determining, in response to receiving a do not interfere (DNI) control input from a control device for the multimedia device, that the multimedia device is operating in a DNI mode. In the DNI mode, the multimedia device persistently maintains a state of the multimedia device. The method also includes operating the multimedia device according to the DNI mode, in response to receiving an operation control input. The operation control input represents a request to change the state.

### BRIEF DESCRIPTION OF THE DRAWINGS

Advantages of the invention may become apparent upon reading the following detailed description and upon reference to the drawings in which:

FIG. 1 is a simplified block diagram an exemplary system in accordance with one embodiment of the present invention;

FIG. 2 is a simplified block diagram an exemplary system in accordance with one embodiment of the present invention;

FIG. 3 is an exemplary menu interface in accordance with one embodiment of the present invention;

FIG. 4 is a flow chart illustrating an exemplary technique for a multimedia device operable by a control device; and

FIG. 5 is a simplified block diagram of an exemplary system in accordance with one embodiment of the present invention.

### DETAILED DESCRIPTION

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

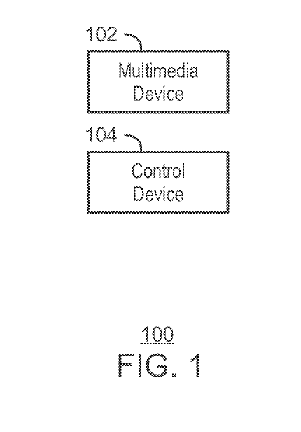

Turn initially to FIG. 1, a block diagram of an exemplary system in accordance with one embodiment is illustrated and generally designated by a reference numeral 100. FIG. 1 illustrates an exemplary system 100 incorporating a multimedia device 102 and control device 104, and operable according to the principles of the present invention. The multimedia device 102 provides content, in response to selections made on the control device 104. The multimedia device 102 may be any content-providing device, such as, but not limited to, personal video recorders, satellite set-top boxes (STBs), cable STBs, and internet protocol television (IPTV) STBs. The control device 104 is configured to operate the multimedia device 102. Control devices may include, but are not limited to, a remote control, remote control local keyboard, remote data port command, internet access or device providing any incoming input to the multimedia device 102.

For example, the control device 104 may be the front panel of a STB including keys that a user presses to select the content provided by the multimedia device 102. Based on these inputs to the control device 104 (control inputs), the multimedia device provides the content as selected.

In an embodiment of the present disclosure, the multimedia device 102 operates in a standard mode and a DNI mode. In the standard mode, the multimedia device 102 is responsive to control inputs from the control device 104. Any particular state of the multimedia device 102 may be changed. For example, in the standard mode, it is possible to change channels, inputs, and so on, on the multimedia device 102. However, in the DNI mode, the multimedia device 102 may not be responsive to control inputs. In one embodiment, software on the multimedia device 102 provides the DNI mode, during which control inputs received from the control device do not modify the current state of the multimedia device.

In one embodiment, even though the multimedia device 102 is not processing control inputs, the multimedia device 102 may provide an indicator that a key is pressed on the control device 104. For example, a light on the front panel of a STB may blink in response to each key press. Alternatively, a non-obtrusive blinking may be provided on a display device.

The DNI mode is useful, for example, when children are around playing with a remote control, or inadvertently pressing keys on the front panel of a digital signal receiver, such as a STB. The DNI mode is also useful in applications, such as the testing of multiple receivers. In testing, receivers may be arranged in a rack, each responsive to a single remote control. By using the DNI mode, the flexibility of testing may be expanded by restricting which receivers respond to the remote control.

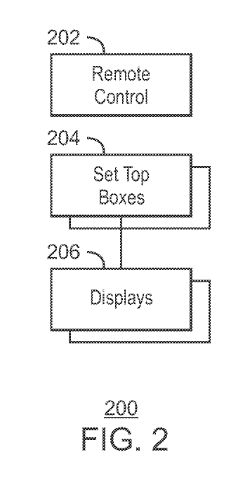

FIG. 2 is a simplified block diagram an exemplary system 200 in accordance with one embodiment of the present invention. The system 200 includes a remote control 202, with various keys, for operating set-top boxes 204 and displays 206. In one embodiment, the set-top boxes 204 may be placed in DNI mode by pressing a specified sequence of keys, e.g., a DNI code. For example, the set-top box 204 may be placed in DNI mode by pressing a sequence of a red-colored key and four digit keys on the remote control 202. While in DNI mode, the set-top box 204 ignores any subsequent operational control inputs from the remote control 202. Accordingly, on reception of the 4th digit, the set-top boxes 204 stop processing any new control inputs. Operational control inputs may be any control inputs that modify the current state of the set-top box. The set-top box 204 may be returned to standard mode using the DNI code. For example, the same sequence of keys used to enter in the DNI mode may be used to get out of it. Accordingly, on the reception of the 4th valid digit of the DNI code, the control inputs are active again.

In one embodiment, the 4-digit code may be briefly presented, e.g., shown on the display 206, for a predetermined number of seconds. Such a display may be provided at the selection of a user through a menu.

The set-top box 204 may also be returned to standard mode from DNI mode using a menu selection. However, because direct access to the interface 300 may not be available in DNI mode, a specified sequence of keys may be used to retrieve the DNI menu interface 300. If the front panel of a multimedia device is disabled, then replacement keys may be used to retrieve the interface 300.

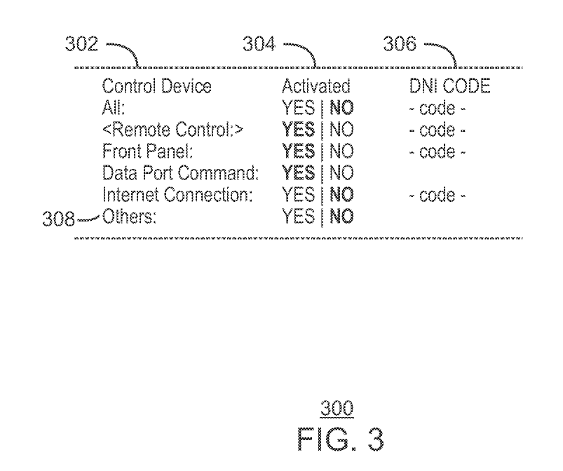

FIG. 3 is an exemplary DNI menu interface 300 in accordance with one embodiment. The interface 300 enables a configuration of DNI mode parameters, such as the number of seconds the DNI code is displayed. The interface 300 shows a list of control devices 302 that operate the particular multimedia device showing the interface 300. The column, activated 304, indicates whether the multimedia device is in DNI mode currently for the specific control device 302. The column, DNI code 306, may represent the DNI code for the control device 302. The DNI menu interface 300 may also allow user selections regarding the display of the DNI code, and for how long (not shown).

The selection between items is possible by using arrow keys on a remote controller to make the various selections. In one embodiment, selecting the DNI code 306 may display the actual code, enable a specified DNI code 306. In one embodiment, each control device 302 has a different DNI code 306. Disabling the DNI mode (selecting NO) for ALL control devices 302, may enable menu navigate into the other items 308 selection.

The other items 308 refer to scenarios where a specific frame for a Data port command (serial) or internet could be sent to re-authorize connectivity and resume standard mode from DNI mode. The command may be specified in a predefined format, i.e., <Tag><Length><data>.

In one embodiment, multimedia devices may be returned to standard mode from DNI mode by rebooting the multimedia device. Additionally, DNI mode may be limited to a specified time period of operation, after which the multimedia device returns to standard mode. Further, a return to standard mode may be initiated in response to a common alerting protocol (CAP), or special entitlement management message from a broadcaster. However, overwriting one DNI mode to another one by introducing a new code is not permitted.

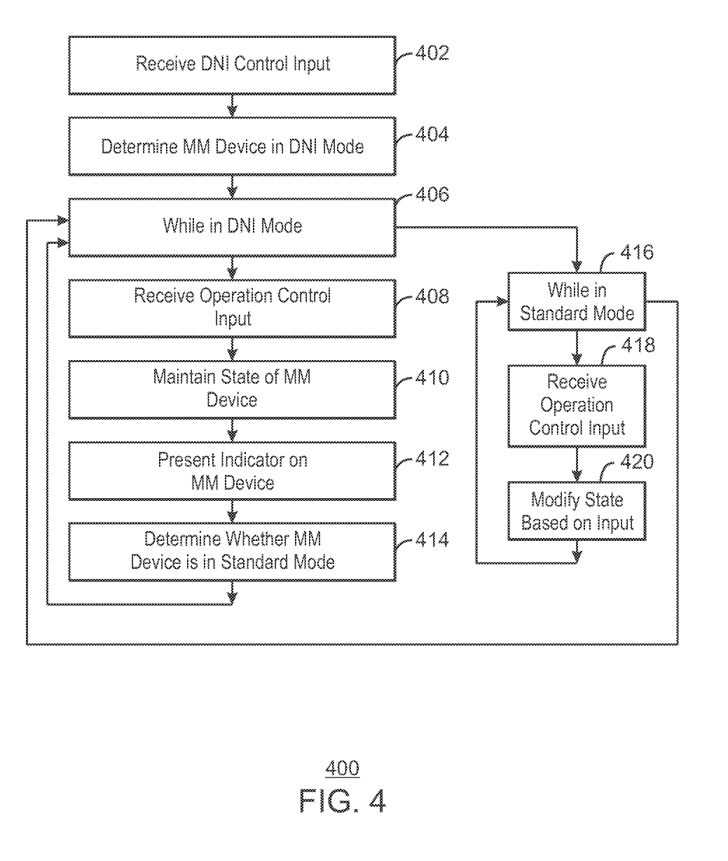

FIG. 4 is a flow chart illustrating an exemplary method 400 for operating a multimedia device with a control device in accordance with embodiments of the present disclosure. At block 402, the multimedia device 102 receives a DNI control input from the control device 104. In response to receiving the DNI control input, at block 404 it is determined that the multimedia device is operating in DNI mode. In DNI mode, the multimedia device 102 persistently maintains the same state. Channels cannot be changed, recordings cannot be stopped, for example.

Blocks 406-414 are repeated while the multimedia device 102 is in DNI mode. At block 408, the multimedia device 102 receives an operation control input. At block 410, the multimedia device 102 maintains its current state. At block 412, the multimedia device 102 presents an indicator that a control input was received during the DMI mode. At block 414, it may be determined whether the multimedia device 102 has returned to the standard mode. As stated previously, the multimedia device 102 may return to standard mode automatically after a specified time period, or in response to a request from various inputs.

Blocks 416-420 are repeated while the multimedia device 102 is in standard mode. When the multimedia device 102 leaves standard mode, it may return to DNI mode at block 406.

At block 418, the multimedia device 102 receives a control input. At block 420, the multimedia device 102 modifies its state based on the control input. Modifying the state may include returning to DNI mode, selecting a new channel, adjusting the volume, and so on.

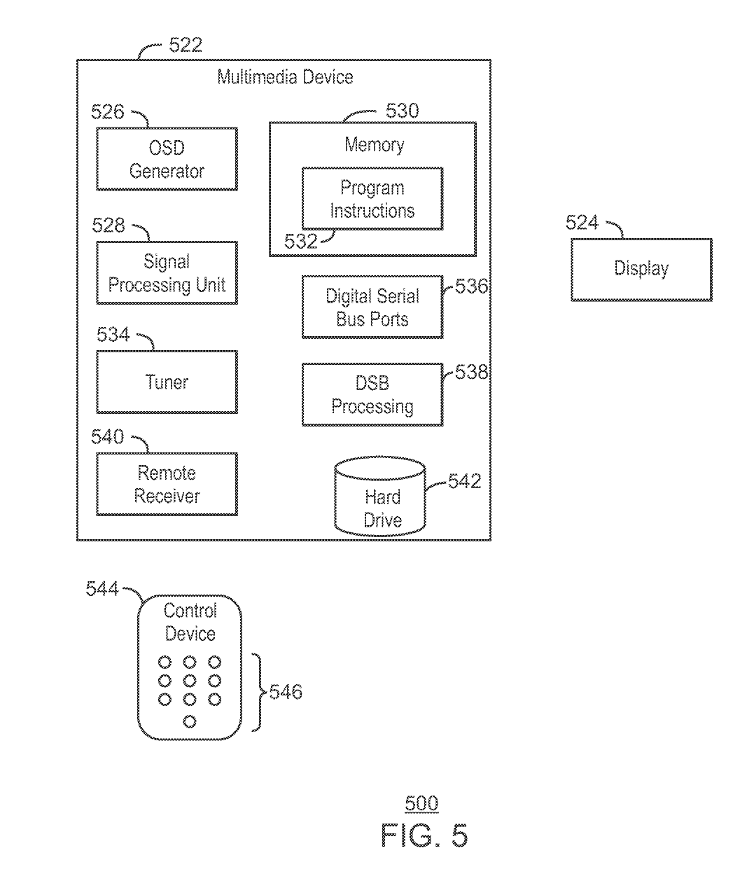

FIG. 5 is a simplified block diagram of an exemplary system in accordance with one embodiment. Being exemplary, the system 500 represents physical embodiments of a multimedia device 522 and display 524, operable in accordance with the principles of the present disclosure. The multimedia device 522 may be a device for processing multimedia signals, such as a set top box device, digital video recorder, digital video disc (DVD) player, high-definition (HD) disc player, streaming device, and the like. The multimedia device 522 may be connected, or otherwise coupled to, the display 524.

Alternatively, in an example system 500, the multimedia device 522 may be a television, which includes the display 524. The display 524 may include speakers (not shown). The speakers may be connected, or otherwise coupled to, the display 524 or the multimedia device 522. The multimedia device 522 has basic functionality and features consistent with typical television apparatus as well as the present functionality described herein.

The multimedia device 522 is operable, configured or adapted to process digital television signals, digital audio/video (A/V) content and the like (collectively, digital content), as well as analog television signals and analog NV content and the like (collectively, analog content) from various input sources available for the multimedia device 522. It is noted, however, that the multimedia device 522 may process only digital content. The various input sources may include A/V signals from a satellite or cable provider, tunable digital content, DVDs, HD video and audio content, and the like. In one embodiment, the source may be a server that streams content over a local area network, or a wide area network, such as the Internet.

The multimedia device 522 includes an on-screen display (OSD) generator 526 that is operable to provide the graphics, text and the like for on-screen menus on the display 524. The display 524 is further operable to display menus or user selectable options for setting and canceling the DNI mode. The menus or options may be displayed in response to user input, television system signals, signals from components, and may accept user input for selection of various options.

The multimedia device 522 may include a television signal processing unit 528 that is operable, configured or adapted to process digital television signals such as MPEG2 digital signals. The television signal processing unit 528 may also provide analog television signal processing if the multimedia device 522 supports analog television signals. The television signal processing unit 528 also provides control of the various television apparatus components, features and functions of the multimedia device 522, and the like. The multimedia device 522 further includes memory 530 storing program instructions 532. The program instructions 532 are used by the multimedia device 522 (i.e. the television signal processing unit 528 and digital serial bus processing (DSB) unit 538) for operation of the multimedia device 522 in accordance with the present principles.

The multimedia device 522 may include a tuner 534 that is operable to receive tunable digital content. Additionally, the multimedia device 522 may include digital serial bus ports 536 for connection and communication with one or more DSB-compliant devices or components. The digital serial bus compliant devices or components may be a digital recording device having a hard disk drive, a DSB box, or the like. In an example embodiment, the digital serial bus is an IEEE 1394 digital serial bus and the components connected to the DSB ports 536 are IEEE 1394 compliant devices. The DSB unit 538 would thus perform IEEE 1394 processing. In this way, the multimedia device 522 provides for recording functionality over the IEEE 1394 bus by establishing a connection between an IEEE 1394 compliant recordable device and an IEEE 1394 compliant recording device.

In accordance with the claimed subject matter, the system 500 provides a multimedia device with a DNI mode, where the state of the multimedia device is maintained even though operational inputs are being received from a control device to modify the state.

The multimedia device 522 may accept user input via a control device 544 with various buttons 546 for operating the multimedia device 522. The control device 544 sends user-initiated input signals to a receiver 540. The control device 544 may be may be, for example, a panel on a set top box.

In one embodiment, the control device 544 is a remote controller. In such an embodiment, the remote controller and the receiver 540 may use infrared (IR), radio frequency (RF), or other transmission means. In an example embodiment, the display 524 also includes a remote receiver (not shown).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method for a multimedia device, comprising:
in response to receiving a do not interfere (DNI) control input from a control device for the multimedia device, determining that the multimedia device is operating in a DNI mode, wherein the multimedia device persistently maintains a state of the multimedia device; and
in response to receiving an operation control input, operating the multimedia device according to the DNI mode, wherein the operation control input represents a request to change the state.

2. The method of claim 1, comprising:
in response to receiving a cancel DNI control input after receiving the DNI control input, determining that the multimedia device is operating according to a standard mode, wherein the multimedia device modifies the state based on a future operation control input; and
in response to receiving the future operation control input, operating according to the standard mode.

3. The method of claim 2, comprising:
in response to receiving the DNI control input from the control device, determining that one or more additional multimedia devices are operating in the DNI mode;
in response to receiving the operation control input, operating the one or more additional multimedia devices according to the DNI mode;
in response to receiving the cancel DNI control input after receiving the DNI control input, determining that the one or more additional multimedia devices are operating according to the standard mode; and
in response to receiving the future operation control input, operating the one or more additional multimedia devices according to the standard mode.

4. The method of claim 1, wherein the DNI control input comprises a specified sequence of keys of the control device.

5. The method of claim 4, wherein the cancel DNI control input comprises the specified sequence of keys.

6. The method of claim 1, comprising:
in response to receiving a menu control input from the control device, presenting a menu on the multimedia device, wherein the menu enables a selection of the DNI mode; and
in response to the selection, providing the DNI control input for the multimedia device.

7. The method of claim 6, wherein the cancel DNI control input comprises a specified code sequence.

8. The method of claim 7, comprising:
in response to receiving an enable menu control input, presenting the menu on the multimedia device, wherein the menu enables a selection of the standard mode; and
in response to the selection of the standard mode, operating the multimedia device according to the standard mode.

9. The method of claim 1, comprising, in response to receiving the operation control input, presenting an indicator on the multimedia device, wherein the indicator indicates:
the multimedia device is operating according to the DNI mode; and
the operation control input is received.

10. The method of claim 1, comprising operating the multimedia device according to the standard mode, in response to one of:
a reboot of a receiver of the multimedia device;
an end of a specified time period; and
receiving an entitlement management message from a broadcaster to the multimedia device.

11. A multimedia device configured to:
receive, by a remote receiver, a do not interfere (DNI) control input from a control device for the multimedia device;
determine, by a processor of the multimedia device, that the multimedia device is operating in a DNI mode, wherein the multimedia device persistently maintains a state of the multimedia device;
receive, by the remote receiver, an operation control input from the control device;
operate, by the processor, the multimedia device according to the DNI mode;
receive, by the remote receiver, a cancel DNI control input after the DNI control input is received;
determine, by the processor, that the multimedia device is operating according to a standard mode, wherein the multimedia device modifies the state based on a future control input received from the control device;
receive, by the remote receiver, the future control input; and
operate, by the processor, the multimedia device according to the standard mode.

12. The multimedia device of claim 11, configured to:
receive, by the remote receiver, a menu control input from the control device;
present a menu, by an on screen display generator, on the multimedia device, wherein the menu enables a selection of the DNI mode;
send, by the control device, the DNI control input to the multimedia device;
receive, by the remote receiver, an enable menu control input from the control device;
present the menu, by the on screen display generator, on the multimedia device, wherein the menu enables a selection of the standard mode;
receive, by the remote receiver, the selection; and
operate the multimedia device according to the standard mode.

13. The multimedia device of claim 12, comprising a display configured to present the menu on the multimedia device.

14. The multimedia device of claim 11, configured to:
determine, by the processor, that one or more additional multimedia devices operate in the DNI mode; and
operate, by a corresponding processor of the additional multimedia devices, the one or more additional multimedia devices according to the DNI mode.

15. The multimedia device of claim 14, configured to:
determine, by the processor, that the one or more additional multimedia devices operate according to the standard mode; and
operate, by a corresponding processor of the additional multimedia devices, the one or more additional multimedia devices according to the standard mode.
